(19) United States
(12) Patent Application Publication
(10) Pub. No.: US 2010/0251112 A1
(43) Pub. Date: Sep. 30, 2010

(54) BIMODAL TOUCH SENSITIVE DIGITAL NOTEBOOK

(75) Inventors: Kenneth Paul Hinckley, Redmond, WA (US); Georg Petschnigg, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/410,311

(22) Filed: Mar. 24, 2009

(51) Int. Cl. G06F 3/01

(52) U.S. Cl. 715/702

(57) ABSTRACT

A touch sensitive computing system, including a touch sensitive display and interface software operatively coupled with the touch sensitive display. The interface software is configured to detect a touch input applied to the touch sensitive display and, in response to such detection, display touch operable user interface at a location on the touch sensitive display that is dependent upon where the touch input is applied to the touch sensitive display.

### BACKGROUND

Touch sensitive displays are configured to accept inputs in the form of touches, and in some cases approaching or near touches, of objects on a surface of the display. Touch inputs may include touches from a user's hand (e.g., thumb or fingers), a stylus or other pen-type implement, or other external object. Although touch sensitive displays are increasingly used in a variety of computing systems, the use of touch inputs often requires accepting significant tradeoffs in functionality and the ease of use of the interface.

### SUMMARY

Accordingly, a touch sensitive computing system is provided, including a touch sensitive display and interface software operatively coupled with the touch sensitive display. The interface software is configured to detect a touch input applied to the touch sensitive display and, in response to such detection, display touch operable user interface at a location on the touch sensitive display that is dependent upon where the touch input is applied to the touch sensitive display.

In one further aspect, the touch input is a handtouch input, and the touch operable user interface that is displayed in response is a pentouch operable command or commands. In yet another aspect, the activated user interface is displayed upon elapse of an interval following receipt of the initial touch input, though the display of the activated user interface can be accelerated to occur prior to full lapse of the interval in the event that the approach of a pen-type implement is detected.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a block diagram of an embodiment of an interactive display device.

FIG. 2 shows a schematic depiction of a user interacting with an embodiment of a touch sensitive computing device.

FIG. 3 shows a flow diagram of an exemplary interface method for a touch sensitive computing device.

FIG. 4 shows a schematic depiction of an embodiment of a touch sensitive computing device displaying touch operable commands in response to detecting a rest handtouch.

FIG. 5 shows a schematic depiction of an embodiment of a touch sensitive computing device displaying touch operable commands in response to detecting a rest handtouch and pentip approach.

FIG. 6 shows a schematic depiction of an embodiment of a touch sensitive computing device displaying a coarse dragging of an object via a handtouch.

FIG. 7 shows a schematic depiction of an embodiment of a touch sensitive computing device displaying a precise dragging of an object via a pentouch.

FIG. 8 shows a schematic depiction of an embodiment of a touch sensitive computing device displaying a user selecting an object via a handtouch.

FIG. 9 shows a user duplicating an object of FIG. 8 via a pentouch.

FIG. 10 shows a user placing via a pentouch a duplicated object of FIG. 9.

FIG. 11 shows a schematic depiction of an embodiment of a touch sensitive computing device displaying a user selecting a collection via a handtouch.

FIG. 12 shows a user expanding the collection of FIG. 11 via a bimanual handtouch.

FIG. 13 shows a user selecting an object from the collection of FIG. 1 via a pentouch.

### DETAILED DESCRIPTION

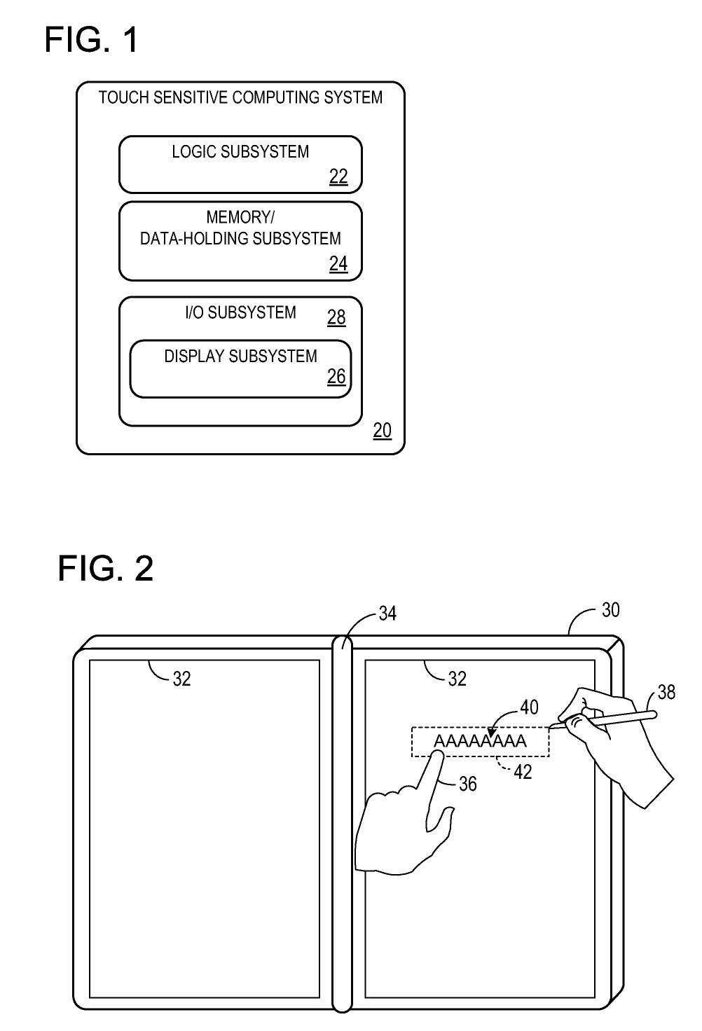

FIG. 1 shows a block diagram of an embodiment of a touch sensitive computing system 20 comprising a logic subsystem 22 and a memory/data-holding subsystem 24 operatively coupled to the logic subsystem 22. Memory/data-holding subsystem 24 may comprise instructions executable by the logic subsystem 22 to perform one or more of the methods disclosed herein. Touch sensitive computing system 20 may further comprise a display subsystem 26, included as part of I/O subsystem 28, which is configured to present a visual representation of data held by memory/data-holding subsystem 24.

Display subsystem 26 may include a touch sensitive display configured to accept inputs in the form of touches, and in some cases approaching or near touches, of objects on a surface of the display. In some cases, the touch sensitive display may be configured to detect “bimodal” touches, wherein “bimodal” indicates touches of two different modes, such as a touch from a user's finger and a touch of a pen. In some cases, a touch sensitive display may be configured to detect “bimanual” touches, wherein “bimanual” indicates touches of a same mode (typically handtouches), such as touches from a user's index fingers (different hands), or touches from a user's thumb and index finger (same hand). Accordingly, in some cases a touch sensitive display may be configured to detect both bimodal and bimanual touches.

Computing system 20 may be further configured to detect bimodal and/or bimanual touches and distinguish such touches so as to generate a response dependent on the type of touch detected. For example, a human touch may be used for broad and/or coarse gestures of lesser precision, including but not limited to instantly selecting objects via tapping, group-selecting and/or lassoing objects, dragging and dropping, “pinching” objects by squeezing or stretching gestures, and gestures to rotate and/or transform objects. Additionally, in a bimanual mode, combinations of such touches may also be utilized.

In another example, a touch from an operative end of a pen-type touch implement (i.e. a pen touch) may be used for fine and/or localized gestures of a higher precision including but not limited to writing, selecting menu items, performing editing operations such as copying and pasting, refining images, moving objects to particular locations, precise resizing and the like. Additionally, in a bimodal mode, combinations of such human touches and pen touches may also be utilized, as described below with reference to FIG. 2.

In addition to touching actual touches, system 20 may be configured to detect near touches or approaches of touches. For example, the touch sensitive display may be configured to detect an approach of a pen touch when the pen is approaching a particular location on the display surface and is within range of or at a predetermined distance from the display surface. As an example, the touch sensitive display may be configured to detect a pen approaching the display surface when the pen is within two centimeters of the display surface.

The touch sensitive computing systems described herein may be implemented in various forms, including a tablet laptop, smartphone, portable digital assistant, digital notebook, and the like. An example of such a digital notebook is shown in FIG. 2 and described in more detail below.

Logic subsystem 22 may be configured to run interface instructions so as to provide user interface functionality in connection with I/O subsystem 28, and more particularly via display subsystem 26 (e.g., a touch sensitive display). Typically, the interface software is operatively coupled with the touch sensitive display of display subsystem 26 and is configured to detect a touch input applied to the touch sensitive display. In response to such detection, the interface software may be further configured to display touch operable user interface at a location on the touch sensitive display that is dependent upon where the touch input is applied to the touch sensitive display. As an example, touch (or pen) operable icons may appear around a location where a user rests his finger on the display. This location may depend on the extent of the selected object (e.g. at the top of the selection). Touch operable icons also may appear at a fixed location, with the touch modulating the appearance (fade in) and release triggering the disappearance of icons or toolbars. The location of icons may also be partially dependent on the touch location, e.g. appearing in the right margin corresponding to the touch location.

FIG. 2 shows a schematic depiction of a user interacting with an embodiment of an interactive display device. As an example, such an embodiment of an interactive display device may be a touch sensitive computing system such as digital notebook 30. Digital notebook 30 may include one or more touch sensitive displays 32. In some embodiments, digital notebook 30 may include a hinge 34 allowing digital notebook 30 to foldably close in the manner of a physical notebook. Digital notebook 30 may further include interface software operatively coupled with the touch sensitive display, as described above with reference to FIG. 1.

As shown in FIG. 2, digital notebook 30 may detect touches of a user's finger 36 and touches of a pen 38 on touch sensitive displays 32. Digital notebook 30 may be further configured to detect approaches of pen 38 when pen 38 is within a predetermined distance from touch sensitive display 32. As an example, a user's finger 36 may be used to select an object 40 displayed on touch sensitive display 32, and in response touch sensitive display 32 may be configured to display an indication that the item has been selected, such as by displaying a dashed-line box 42 around object 40. The user may then perform a more precise gesture, such as a precise resizing of object 40 using pen 38. It should be understood that this but one of many potential examples; selecting and resizing an object is just one of many operations that may be performed with a combination of touches and pen touches. Furthermore note that the scope of the object(s) selected may depend on the location, extent, or shape of the contact region(s) formed by the finger(s) and hand(s) contacting the display. Other examples are described in more detail below.

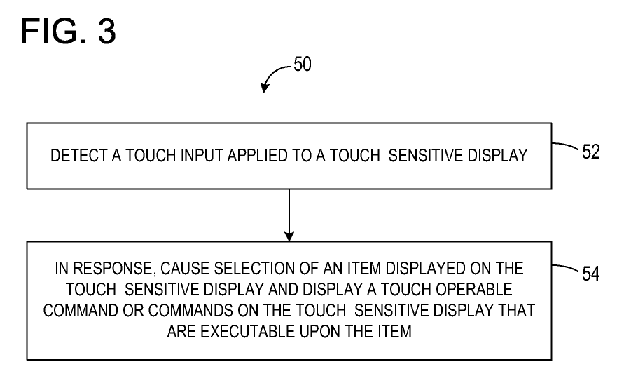

FIG. 3 shows an exemplary interface method 50 for a touch sensitive computing device. At 52, method 50 includes detecting a touch input applied to a touch sensitive display. A touch input, as described herein, may include a touch of a physical object on the touch sensitive display, such as a thumb or finger (i.e. a handtouch). In some cases, such a touch input may be of an operative end of a pen-type touch implement (i.e. a pentouch). Further, a touch input may also include a combination of a handtouch and pentouch, and/or a combination of a handtouch and an approach of the pen (i.e. pentip approach). In some embodiments, a touch input of a handtouch type may include a “tap” handtouch, wherein a user taps the touch sensitive display such that the touch sensitive display detects a commencing of the touch followed by a cessation of the touch. In many cases, it will be desirable that tap handtouches are processed by the interface software to cause selection of items on the touch sensitive display.

In some embodiments, a touch input of a handtouch type may include a “rest” handtouch, wherein a user touches the touch sensitive display and remains touching the display device, such that the touch sensitive display detects a commencing of a prolonged touch. In some embodiments, while the touch sensitive display device is detecting a rest handtouch, the display device may additionally detect an approach of a pentip, such that detecting a touch input as described above at method 50 may include detecting the combination of a rest handtouch and a pentip approach. As discussed below, a rest touch from a user's hand or other object may be processed to cause display of touch operable commands on the display screen. The added input of an approaching pentouch can modify the process of making the touch operable commands displayed on the screen. For example, an approaching pen touch may cause the touch operable commands to be displayed more quickly, as will be discussed in examples below.

At 54 method 50 includes, in response to detecting the touch input, causing selection of an item displayed on the touch sensitive display and displaying a touch operable command or commands on the touch sensitive display that are executable upon the item. For example, as described above, a touch input may be used to select an item displayed on the touch sensitive display. Further, upon selection of an item, the touch sensitive display may display on the touch sensitive display device a touch operable command or commands. Alternatively, the touch operable commands may be displayed in response to a “rest” handtouch applied to the displayed item.

In any case, the touch operable commands that appear may include selectable options corresponding to the item of any number and types of contextual menus, such as formatting options, editing options, etc. In some embodiments, the displaying of touch operable commands may include revealing the touch operable commands via “fading in”, and/or “floating in”, such that the touch operable commands slowly fade into view and/or move into the place on the display where they will be activated from. Revealing the touch operable commands in such a manner can provide a more aesthetic user experience by avoiding flashing and/or sudden changes of images on the display, which may be a distraction to the user. Furthermore, the progressive nature of the fade in/float in method is that the user notices the change to the display and the user's eye is drawn to the particular location from which the faded-in commands can be activated.

Further, such touch operable command or commands may be displayed on the touch sensitive display in a location that is dependent upon the location of the item that has been selected or that will be acted upon. For example, the touch operable command or commands may be displayed as a contextual menu displayed near the item.

Additionally, or alternatively, the touch operable command or commands may be displayed at a location dependent upon where the touch input is applied to the touch sensitive display. For example, the touch operable user interface may be displayed as a contextual menu displayed near a finger providing the touch input.

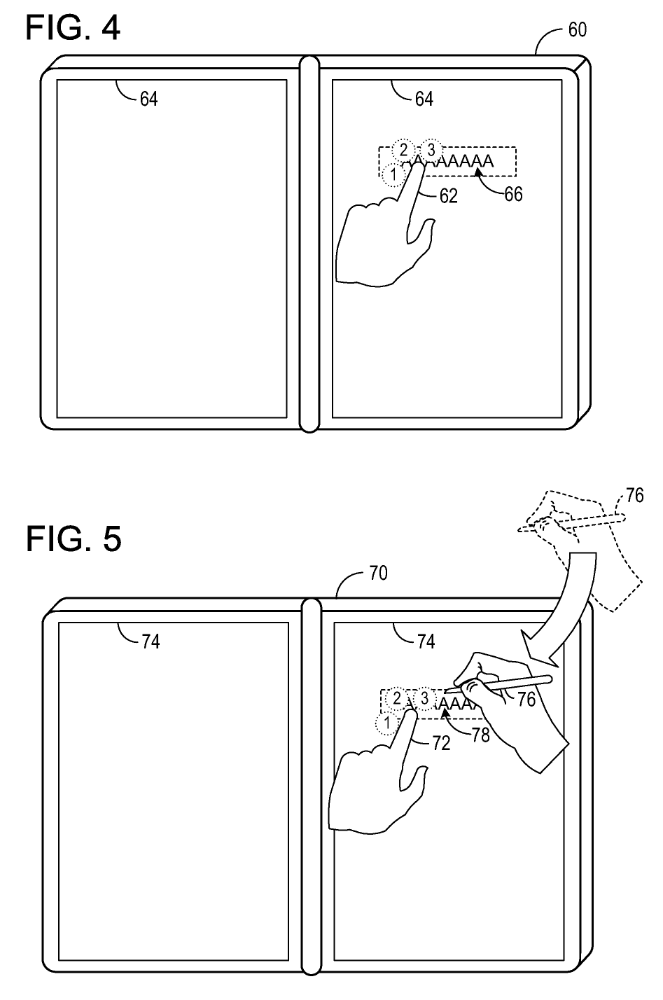

In many cases, it will be desirable that the interface software display the touch operable commands (e.g., the commands that are faded in) only after lapse of a predetermined interval following the activating input (e.g., the rested handtouch). As an example, FIG. 4 shows a schematic depiction of an embodiment of an interactive display device 60. Upon detecting a rest handtouch of a user's finger 62 on touch sensitive display 64 at image 66, touch sensitive display 64 reveals touch operable commands “1,” “2” and “3” by visually fading the commands into view as indicated by the dotted lines of the commands. In some cases, touch sensitive display 64 may be configured to display the commands after a predetermined interval (e.g. two seconds) following detection of the touch input. It is to be understood that an interval of two seconds is exemplary in that the duration of the predetermined interval may be of any suitable length of time. Alternatively, a touch and release (as opposed to a touch and hold) may display commands that the user subsequently activates using the pen or a finger.

Commands “1,” “2” and “3” are exemplary in that any number of commands may appear in any number of different configurations, and the commands may further be associated with any number of options being presented to the user. Additionally, in some cases the faded-in commands will be selected based upon characteristics of the item, as detected by the interface software. For example, in the case of a text item, the corresponding touch operable commands may be editing commands such as cut, copy and paste functions. In another example, the corresponding commands related to the text item may be text formatting commands such as font style, font size and font color. In yet another example, the text item may be detected as including potential contact information and/or appointment information, and the corresponding touch operable commands would include functionality for storing items in a personal information management schema including contacts and calendar items.

The method of FIG. 3 may also include additional or alternative steps of processing a detected input to determine if the input is an incidental input, as opposed to being an intentional or desired input. A potentially incidental touch can be ignored, and/or deferred until enough time passes to unambiguously decide (or decide with a higher confidence level) if the touch was intentional or not. As previously indicated, for example, it will often be desirable to ignore and reject touches associated with the hand that is holding the pen implement. Various factors may be employed in assessing whether touches are incidental, including the shape of the contact region, inferences about which hand is touching the input surface, the proximity of a detected pen touch, the underlying objects on the screen, etc.

Further, as shown in FIG. 4, commands “1,” “2” and “3” are displayed on the touch sensitive display 64 in a location that is dependent upon a location of the item. As shown, the commands are displayed near the user's finger 62 and overlapping image 66. Commands may consist of any mix of tap-activated controls, radial menus, draggable controls (e.g. slider), dialing controls (touch down and circle to adjust a value or step through options), crossing widgets, pull down menus, dialogs, or other interface elements.

Such interface software as described above may be further configured to detect an approach of an operative end of a pen-type touch implement toward the location on the touch sensitive display, and when such approach is detected during the predetermined interval of the input touch, the touch operable user interface is displayed prior to full lapse of the predetermined interval. As an example, FIG. 5 shows a schematic depiction of another embodiment of an interactive display device 70. Upon detecting a rest handtouch of a user's finger 72 on touch sensitive display 74, touch sensitive display 74 detects a pentip approach of pen 76. In response to detecting the combination of the rest handtouch and the pentip approach, touch sensitive display immediately reveals commands “1,” “2” and “3” associated with image 78. Thus, in such an embodiment, touch sensitive display 74 may more quickly fade the commands into view in response to a combination of a rest handtouch and pentip approach, than in the case of the rest handtouch by itself. Accordingly, in such an embodiment, the combination of the rest handtouch and pentip approach yields a faster solution to the user of the interactive display device 70, just as a keyboard shortcut may offer a user of a traditional personal computer. In general the visual appearance of the commands and the physical accessibility of the commands may be separated. For example, upon the pen coming close to the hand touching the screen, some or all of the commands may be immediately actionable. As a further example a pen stroke in close proximity to the hand may be understood to select an option from a radial menu represented by command “1” whether or not the command(s) are visually displayed at that time.

Further, in some cases, a touch sensitive computing system comprising a touch sensitive display and interface software operatively coupled with the touch sensitive display, as described herein, may be configured to detect a touch input applied to an item displayed on the touch sensitive display and, in response to such detection, display a pentouch operable command or commands on the touch sensitive display that are executable on the item.

Pentouch operable commands may be any suitable type, including the touch operable commands described above. Additionally, pentouch operable commands may further include touch operable commands of a more precise nature, making use of the specific, and relatively small, interaction area of the display of which the operative end of a pen-type touch implement interacts with the touch sensitive display. Accordingly, pentouch operable commands may afford the user the potential advantage of easily completing precision tasks without having to change to a different application mode and/or view the digital workspace in a magnified view. In other words, pentouch operable commands may facilitate precise manipulation of objects displayed on a touch sensitive display in a controlled and precise manner not feasible with a finger tip which may occlude a much larger interaction area of the display.

In some cases a touch sensitive display may be configured to display pentouch operable commands after a predetermined interval following detection of a touch input, as described above with reference to touch operable commands.

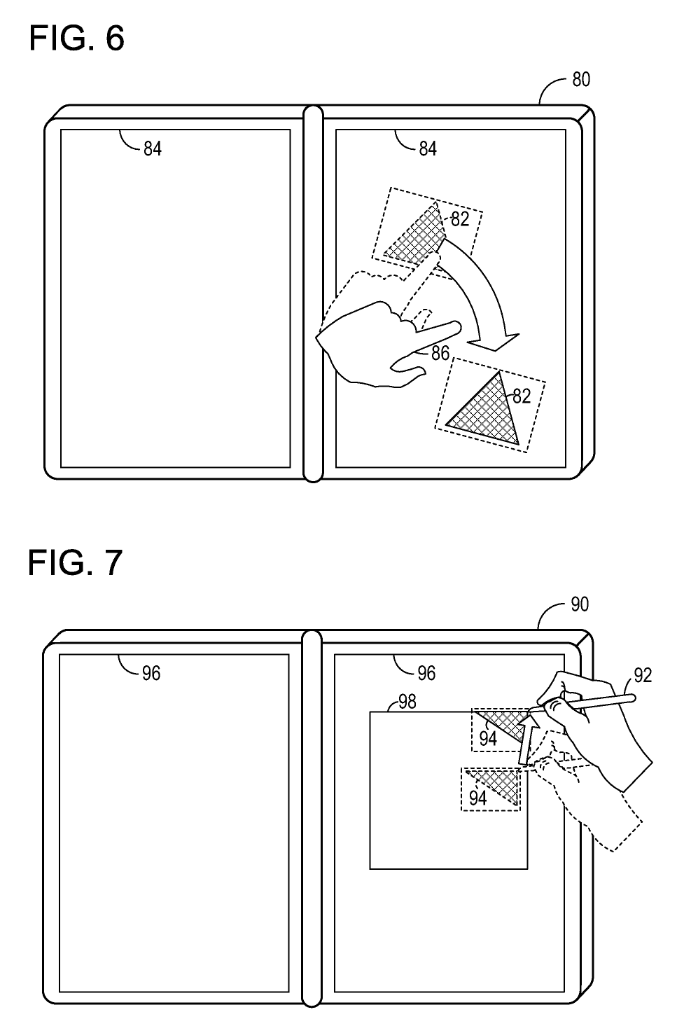

In some embodiments, pentouch operable commands may include a move command executable via manipulation of a pen-type implement to cause movement of the item to a desired location on the touch sensitive display. As an example, FIG. 6 shows coarse dragging of an object via a handtouch and FIG. 7 shows precise dragging of an object via a pentouch, as described in more detail below.

FIG. 6 shows a schematic depiction of an embodiment of an interactive display device 80 displaying image 82 on touch sensitive display 84. As shown, a user's finger 86 is performing a coarse gesture to virtually “toss” image 82. Thus, the touch sensitive display 84 displays the image being adjusted from an original location indicated by dashed-line to a final location indicated by solid-line.

FIG. 7 shows a schematic depiction of an embodiment of an interactive display device 90 displaying a precise dragging of an object via a pentouch. As shown, a pen 92 is performing a precise dragging of image 94. Thus, the touch sensitive display 96 displays the image being adjusted from an original location indicated by dashed-line to a final precise location indicated by solid-line. As shown, the user is precisely positioning image 94 adjacent to another object 98 displayed on touch sensitive display 96.

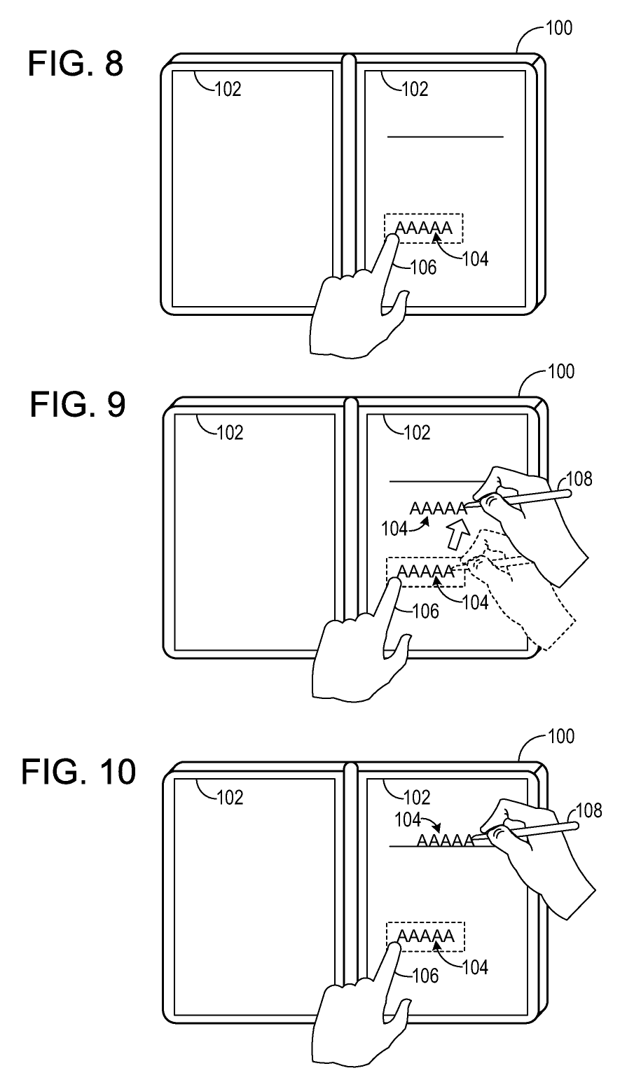

In some embodiments, pentouch operable commands may include a copy and place command executable via manipulation of a pen-type implement to cause a copy of the item to be placed at a desired location on the touch sensitive display. FIGS. 8-10 illustrate an example of such a “copy and place” command. FIG. 8 shows a schematic depiction of an embodiment of an interactive display device 100 displaying on a touch sensitive display 102 a user selecting an object 104 via a handtouch of a user's finger 106. Upon doing so, the user duplicates object 104 via a pentouch 108, as shown in FIG. 9, and begins precisely dragging the duplicated object. Upon duplicating the object, the user precisely drags the duplicated object via a pentouch and precisely places the duplicated object adjacent to a line being displayed on touch sensitive display device 102, as shown in FIG. 10. Likewise, a “copy and toss” command allows a similar transaction to end by tossing the copied item onto a second screen so that the physical screen bezel does not prevent copying objects to a separate screen or off-screen location.

In some embodiments, pentouch operable commands may include a resize command executable via manipulation of a pen-type implement to cause the item to undergo a desired amount of resizing. Such a command may include the touch sensitive display displaying “handles” on the selected image which the pen may use to precisely adjust the size of the selected image.

Further, in some embodiments pentouch operable commands may include a rotate command executable via manipulation of a pen-type implement to cause the item to undergo a desired amount of rotation. Again, by utilizing the pen, such rotation may be more precise and controlled than rotation via a handtouch. By employing two touches instead of the pen, coarse resizing and rotation of selected objects can be achieved without the need to target small selection handles with the pen.

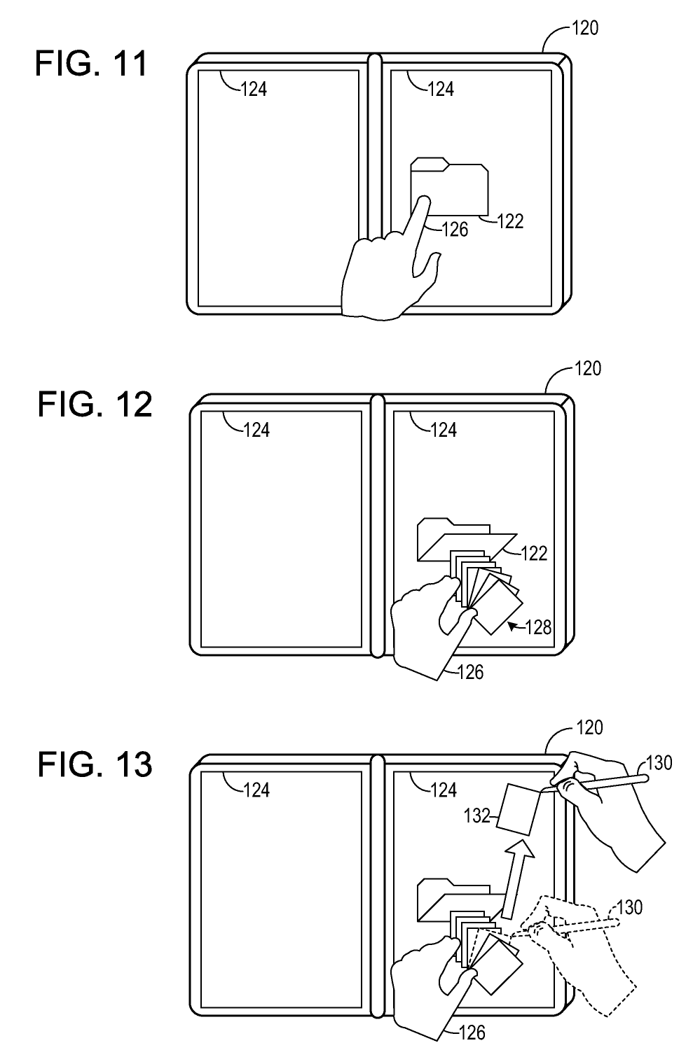

In some embodiments, a combination of a handtouch and pentouch may be utilized to manipulate and/or organize collections of items displayed on a touch sensitive display, an example of which is illustrated in FIGS. 11-13, and described in more detail as follows. FIG. 11 shows an embodiment of an interactive display device 120 displaying a collection 122 of items on a touch sensitive display 124. A handtouch of the user 126 selects the collection, upon which the touch sensitive display 124 displays an expansion of the items 128 within the collection 122 as shown in FIG. 12, which user 126 may further manipulate with a bimanual touch such as by pinching. Upon doing so, a pentouch of pen 130 may be used to select an item 132 from the collection, as shown in FIG. 13. The selected item 132 may then be further manipulated via pentouch in any number of ways as described herein. In this manner, a collection can be manipulated as a unit, or elements within the collection can be manipulated individually without resorting to explicit “group” and “ungroup” commands, for example.

As should be understood from the foregoing, various advantages and benefits may be obtained using the bi-modal (e.g., handtouch and pentouch) and bi-manual (two-handed) interface approaches discussed herein. These approaches may be employed in a variety of settings. As a further example, in a dual-screen embodiment, one screen may be reserved for one type of input (e.g., handtouch) while the other is reserved for another input type (e.g., pentouch). Such a division of labor between the screens may facilitate interpretation of inputs, improve ergonomics and ease of use of the interface, and/or improve rejection of undesired inputs such as incidental handrest or touches to the screen. Another exemplary benefit in the dual-screen environment would be to reduce digitizer power on one of the screens (and thereby lengthen battery charge of the device) upon detection that both of the user's hands are being used to apply inputs to the other screen.

Referring again to FIG. 1, logic subsystem 22 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Memory/data-holding subsystem 24 may include one or more physical devices configured to hold data and/or instructions executable by the logic subsystem to implement the herein described methods and processes. When such methods and processes are implemented, the state of memory/data-holding subsystem 24 may be transformed (e.g., to hold different data). Memory/data-holding subsystem 24 may include removable media and/or built-in devices. Memory/data-holding subsystem 24 may include optical memory devices, semiconductor memory devices, and/or magnetic memory devices, among others. Memory/data-holding subsystem 24 may include devices with one or more of the following characteristics: volatile, nonvolatile, dynamic, static, read/write, read-only, random access, sequential access, location addressable, file addressable, and content addressable. In some embodiments, logic subsystem 22 and memory/data-holding subsystem 24 may be integrated into one or more common devices, such as an application specific integrated circuit or a system on a chip.

When included, display subsystem 26 may be used to present a visual representation of data held by memory/data-holding subsystem 24. As the herein described methods and processes change the data held by the data-holding subsystem, and thus transform the state of the data-holding subsystem, the state of display subsystem 26 may likewise be transformed to visually represent changes in the underlying data. Display subsystem 26 may include one or more display devices utilizing virtually any type of technology. Such display devices may be combined with logic subsystem 22 and/or memory/data-holding subsystem 24 in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A touch sensitive computing system, comprising:
a touch sensitive display; and
interface software operatively coupled with the touch sensitive display,
where the interface software is configured to detect a touch input applied to the touch sensitive display and, in response to such detection, display touch operable user interface at a location on the touch sensitive display, the location being dependent upon where the touch input is applied to the touch sensitive display.

2. The system of claim 1, where the interface software is configured to display the touch operable user interface after lapse of a predetermined interval following detection of the touch input.

3. The system of claim 2, where the interface software is configured to detect approach of an operative end of a pen-type touch implement toward the location on the touch sensitive display, and when such approach is detected during the predetermined interval, the touch operable user interface is displayed prior to full lapse of the predetermined interval.

4. The system of claim 1, where the touch input causes selection of an item displayed on the touch sensitive display, and where touch-operable commands of the touch operable user interface are dependent upon characteristics of the item, as detected by the interface software.

5. The system of claim 4, where the touch-operable commands include cut, copy and paste functions.

6. The system of claim 4, where the touch-operable commands include functionality for storing the item in a personal information management schema including contacts and calendar items.

7. A touch sensitive computing system, comprising:
a touch sensitive display; and
interface software operatively coupled with the touch sensitive display,
where the interface software is configured to detect a handtouch input applied to an item displayed on the touch sensitive display and, in response to such detection, display a pentouch operable command or commands on the touch sensitive display that are executable on the item.

8. The system of claim 7, where the pentouch operable command or commands includes a copy and place command executable via manipulation of a pen-type implement to cause a copy of the item to be placed at a desired location on the touch sensitive display.

9. The system of claim 7, where the pentouch operable command or commands includes a move command executable via manipulation of a pen-type implement to cause movement of the item to a desired location on the touch sensitive display.

10. The system of claim 7, where the pentouch operable command or commands includes a resize command executable via manipulation of a pen-type implement to cause the item to undergo a desired amount of resizing.

11. The system of claim 7, where the pentouch operable command or commands includes a rotate command executable via manipulation of a pen-type implement to cause the item to undergo a desired amount of rotation.

12. The system of claim 7, where interface software is configured to display the pentouch operable command or commands after lapse of a predetermined interval following detection of the handtouch input.

13. The system of claim 12, where the interface software is configured to detect approach of an operative end of a pen-type implement toward the item, and when such approach is detected during the predetermined interval, the pentouch operable command or commands are displayed prior to full lapse of the predetermined interval.

14. An interface method for a touch sensitive computing device, comprising:
detecting a touch input applied to a touch sensitive display;
in response to detecting the touch input, causing selection of an item displayed on the touch sensitive display and displaying a touch operable command or commands on the touch sensitive display that are executable upon the item, where the touch operable command or commands are displayed on the touch sensitive display in a location that is dependent upon a location of the item.

15. The interface method of claim 14, where the touch input is a handtouch input that is rested upon the item.

16. The interface method of claim 15, where the touch operable command or commands are pentouch operable and displayed in proximity to the item following lapse of a predetermined time interval.

17. The interface method of claim 16, further comprising detecting approach of an operative end of a pen-type implement to the item, and if such approach is detected during the predetermined time interval, causing display of the touch operable command or commands prior to full lapse of the predetermined time interval.

18. The interface method of claim 16, where the touch operable command or commands are dependent upon characteristics of item.

19. The interface method of claim 18, where the touch operable command or commands include commands for storing the item in a personal information manager schema including contacts and calendar items.

20. The interface method of claim 18, where the touch operable command or commands include cut, copy and paste commands.
